(19) United States
(12) Patent Application Publication
(10) Pub. No.: US 2023/0268690 A1
(43) Pub. Date: Aug. 24, 2023

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tetsuya MIYAMURA, Mie (JP); Hideto NAKAMURA, Mie (JP); Daisuke SAITO, Mie (JP)

(21) Appl. No.: 18/024,029

(22) PCT Filed: Jul. 30, 2021
(86) PCT No.: PCT/JP2021/028386

§ 371 Date: Feb. 28, 2023

(30) Foreign Application Priority Data
Sep. 14, 2020 (JP) 2020-153560

(51) Int. Cl. H01R 13/639; H01R 13/627; H01R 13/64

(52) U.S. Cl. CPC H01R 13/639; H01R 13/64; H01R 13/6271

(57) ABSTRACT

A connector (1) is provided with pressing portions (52C) for holding hooking portions (72) in a state butted against front locked portions (18A) and stopping a retainer (70) at an initial position in front when connection of a first housing (10) and a second housing (50) is started and allowing the hooking portions (72) to be disengaged from the front locked portions (18A) and making the retainer (70) movable from the initial position to a detection position when the connection of the first and second housings is completed, a lock arm (22) displaceable to a lock position for locking the first and second housings (10, 50) in a connected state by locking the second housing (50) and an unlock position for releasing the locking, and a holding portion (74) for suppressing a displacement of the lock arm (22) from the lock position to the unlock position in the connected state.

### TECHNICAL FIELD

The present disclosure relates to a connector.

### BACKGROUND

A conventional connector is disclosed in patent document 1. An inertial lock is adopted in this connector. This connector is provided with a lock piece including a lock protrusion in a female connector. The lock protrusion of the female connector is locked to a vertical surface formed in a lock recess of a male connector. In this way, a connected state of the female connector and the male connector is held.

### PRIOR ART DOCUMENT

### Patent Document

Patent Document 1: JP 2020-064709 A

### SUMMARY OF THE INVENTION

### Problem to Be Solved

Since this connector enters a state where the lock protrusion cannot be seen from outside as the connection of housings proceeds, it is difficult to determine whether or not the housings have been connected.

The present disclosure was completed on the basis of the above situation and aims to easily detect whether or not housings have reached a connected state and improve a holding force for holding the housings in the connected state.

### Means to Solve the Problem

The present disclosure is directed to a connector with a first housing, a terminal fitting to be inserted into the first housing from behind, a movable member mounted on the first housing movably between an initial position and a detection position forward of the initial position, a second housing to be connected to the first housing, a locked portion provided on the first housing, a hooking portion provided on the movable member, the hooking portion being locked to the locked portion, a pressing portion provided in the second housing, the pressing portion holding the hooking portion in a state butted against the locked portion and stopping the movable member at the initial position in front when connection of the first and second housings is started and allowing the hooking portion to be disengaged from the locked portion and making the movable member movable from the initial position to the detection position when the connection of the first and second housings is completed, a lock arm provided on the first housing, the lock arm being displaceable to a lock position for locking the first and second housings in a connected state by locking the second housing and an unlock position for releasing the locking, and a holding portion provided on the movable member, the holding portion suppressing a displacement of the lock arm from the lock position to the unlock position in the connected state.

### Effect of the Invention

According to the present disclosure, it is possible to easily detect whether or not housings have reached a connected state and improve a holding force for holding the housings in the connected state.

### BRIEF DESCRIPTION OF THE DRAWINGS

FIG. 1 is a perspective view showing a state where female terminal fittings are mounted in a first housing of one embodiment and a retainer is arranged at an initial position when viewed obliquely from a front-upper side.

FIG. 2 is a perspective view showing the state where the female terminal fittings are mounted in the first housing of the embodiment and the retainer is arranged at the initial position when viewed obliquely from a rear-upper side.

FIG. 3 is a plan view showing the state where the female terminal fittings are mounted in the first housing of the embodiment and the retainer is arranged at the initial position.

FIG. 4 is a section along A-A in FIG. 3.

FIG. 5 is a plan view showing a state when the connection of the first housing in which the female terminal fittings are mounted and the retainer is arranged at a detection position and a second housing is completed in the embodiment.

FIG. 6 is a section along B-B in FIG. 5.

FIG. 7 is a section along C-C in FIG. 6.

FIG. 8 is a section along D-D in FIG. 6.

FIG. 9 is a section along C-C in FIG. 6 showing a state when the connection of the first and second housings is started.

FIG. 10 is a section along D-D in FIG. 6 showing the state when the connection of the first and second housings is started.

FIG. 11 is a section along C-C in FIG. 6 showing a state where the first and second housings are at a connection position and the retainer is moving to the detection position.

FIG. 12 is a section along D-D in FIG. 6 showing the state where the first and second housings are at the connection position and the retainer is moving to the detection position.

FIG. 13 is a section along B-B in FIG. 5 showing a state where an abutting surface of a holding portion is in contact with the rear end of a lock arm displaced toward an unlock position rather than a lock position.

### DETAILED DESCRIPTION TO EXECUTE THE INVENTION

### Description of Embodiments of Present Disclosure

First, embodiments of the present disclosure are listed and described.

The connector of the present disclosure is provided with a first housing, a terminal fitting to be inserted into the first housing from behind, a movable member mounted on the first housing movably between an initial position and a detection position forward of the initial position, a second housing to be connected to the first housing, a locked portion provided on the first housing, a hooking portion provided on the movable member, the hooking portion being locked to the locked portion, a pressing portion provided in the second housing, the pressing portion holding the hooking portion in a state butted against the locked portion and stopping the movable member at the initial position in front when connection of the first and second housings is started and allowing the hooking portion to be disengaged from the locked portion and making the movable member movable from the initial position to the detection position when the connection of the first and second housings is completed, a lock arm provided on the first housing, the lock arm being displaceable to a lock position for locking the first and second housings in a connected state by locking the second housing and an unlock position for releasing the locking, and a holding portion provided on the movable member, the holding portion suppressing a displacement of the lock arm from the lock position to the unlock position in the connected state. According to this configuration, since the pressing portion allows the hooking portion to be locked to the locked portion when the connection of the first and second housings is completed, the movable member provided with the hooking portion can be moved to the detection position. In this way, whether or not the connection of the housings has been completed can be easily grasped. Further, since a displacement of the lock arm from the lock position to the unlock position is suppressed by the holding portion, a reduction in holding force for holding the connected state of the housings can be suppressed.

(2) Preferably, an abutting surface for restricting a movement of the movable member to the detection position by contacting a rear end of the lock arm from behind when the lock arm is displaced toward the unlock position rather than the lock position is formed on a tip of the holding portion. According to this configuration, by the contact of the abutting surface of the holding portion with the rear end of the lock arm, it possible to grasp a displacement of the lock arm toward the unlock position rather than the lock position when the housings are connected. Thus, whether or not the housings are locked in the connected state can be detected.

(3) Preferably, the second housing is formed with an opening, the movable member being differently seen in the opening in correspondence with the initial position and the detection position of the movable member. According to this configuration, whether the movable member is at the initial position or at the detection position can be discriminated based on how the movable member is seen through the opening. Thus, whether or not the movable member is at the detection position can be confirmed, in addition to the connected state of the housings.

### Details of Embodiment of Present Disclosure

### [Embodiment]

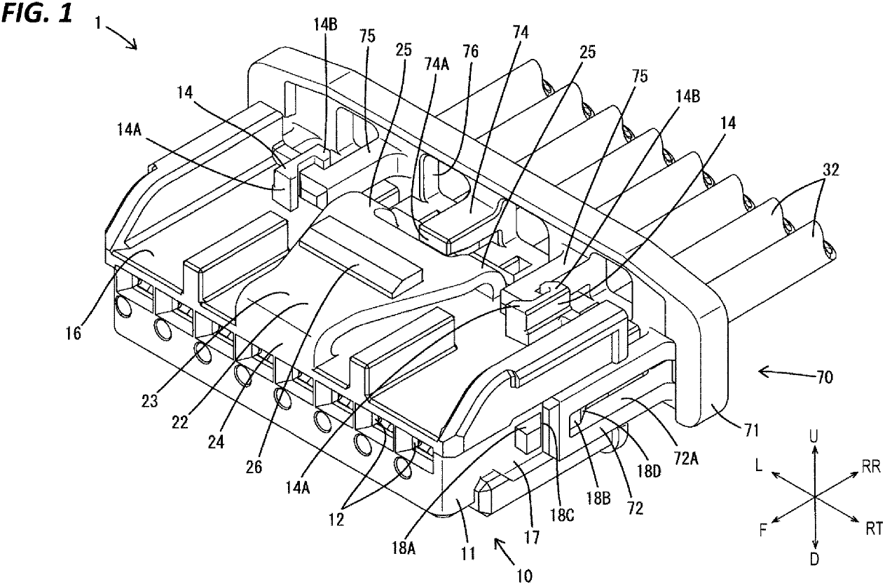

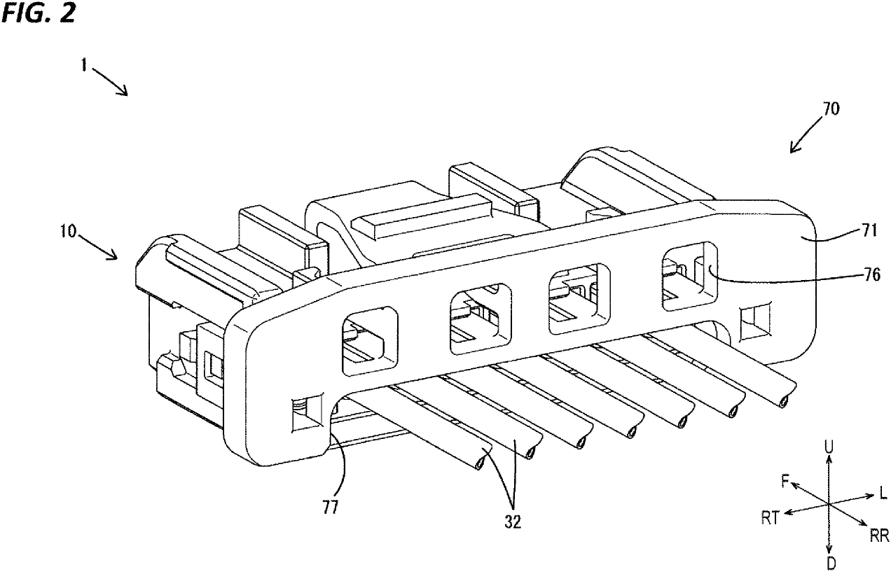

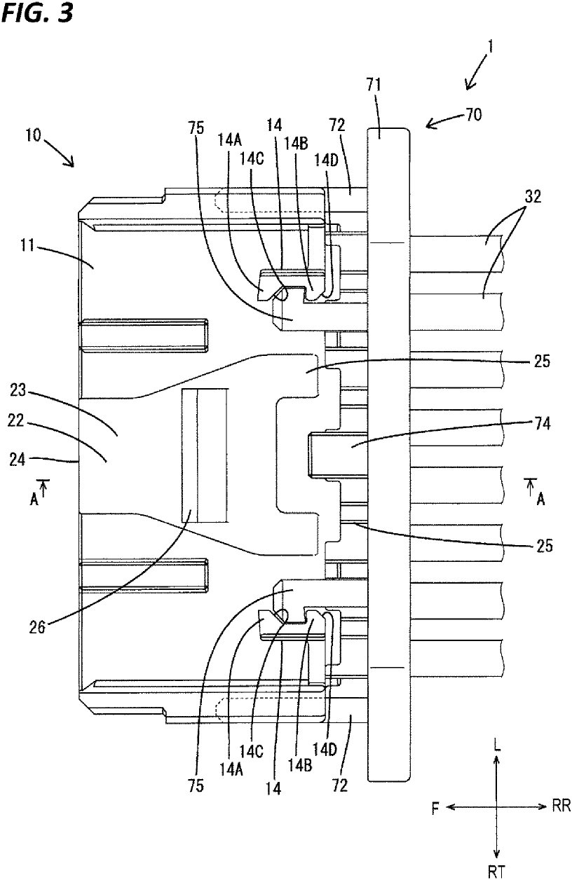

One specific embodiment of the present disclosure is described with reference to FIGS. 1 to 13. Note that, in the following description, left and right sides in FIG. 3 are defined as front and rear sides concerning a front-rear direction. Frontal and back sides in FIG. 3 are defined as upper and lower sides concerning a vertical direction. Upper and lower sides in FIG. 3 are defined as left and right sides concerning a lateral direction.

A connector 1 of this embodiment is provided with a first housing 10 made of synthetic resin, a lock arm 22 provided on the first housing 10, a plurality of female terminal fittings 27, which are terminal fittings, a retainer 70 made of synthetic resin, which is a movable member, and a second housing 50 made of synthetic resin.

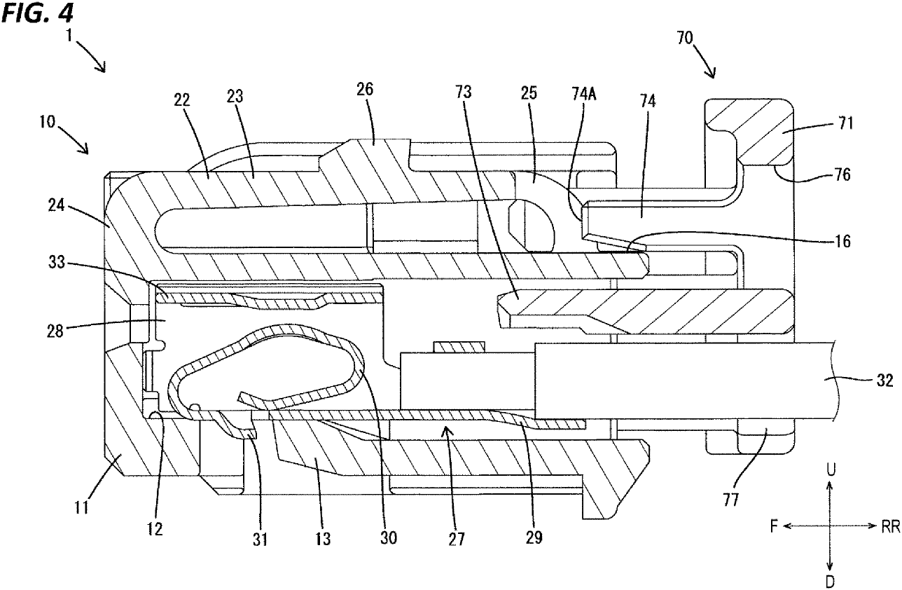

As shown in FIG. 1, the first housing 10 is a single member integrally formed with a terminal accommodating portion 11 having a block-like shape as a whole and the lock arm 22 to be described later. A plurality of terminal accommodation chambers 12 are formed side by side in the lateral direction in the terminal accommodating portion 11. A locking lance 13 resiliently deformable in the vertical direction is formed at the lower surface of the terminal accommodation chamber 12 (see FIG. 4). The rear end of the terminal accommodation chamber 12 is open in the rear end surface of the first housing 10.

A pair of recesses 17 recessed toward a lateral center of the first housing 10 are formed in both left and right outer side surfaces of the first housing 10. A front locked portion 18A, which is a locked portion to be locked by a hooking portion 72 of the retainer 70, and a rear locked portion 18B are provided side by side in the front-rear direction and project in a leftward or rightward direction (hereinafter, also referred to as laterally outward) from the lateral center in each recess 17. Inclined surfaces 18C, 18D inclined rearward and toward the lateral center are formed on rear sides of the front and rear locked portions 18A, 18B. A pair of upper locked portions 14 are provided to project upward on the upper surface of the terminal accommodating portion 11 of the first housing 10. The respective upper locked portion 14 are arranged to the left and right of a rear end part of the lock arm 22. A front protrusion 14A and a rear protrusion 14B are provided to project toward the lateral center on front and rear end parts of a surface of each upper locked portion 14 on the lateral center side. Inclined surfaces 14C, 14D inclined laterally outward toward a rear side are formed on rear sides of the front and rear protrusions 14A, 14B (see FIG. 3).

The lock arm 22 is integrally formed to the first housing 10. The lock arm 22 includes an arm body portion 23, a front coupling portion 24, a pair of rear coupling portions 25 and a protrusion 26. The arm body portion 23 extends in the front-rear direction along an outer surface 16 (upper surface) of the terminal accommodating portion 11. The front coupling portion 24 extends downward from a front end part of the arm body portion 23 and is coupled to the outer surface 16 (upper surface) of the terminal accommodating portion 11. One of the pair of rear coupling portions 25 is arranged on each of both left and right end parts of the rear end of the arm body portion 23, extends downward from a rear end part of the arm body portion 23 and is coupled to the outer surface 16 (upper surface) of the terminal accommodating portion 11. The protrusion 26 is formed to project upward from the upper surface of the arm body portion 23 in a central part in the front-rear direction of the upper surface of the arm body portion 23. The lock arm 22 is formed such that a central part in the front-rear direction of the arm body portion 23 is resiliently deformable in the vertical direction with the front coupling portion 24 and the rear coupling portions 25 as fulcrums. When the lock arm 22 is not resiliently deformed, the arm body portion 23 is arranged at a lock position to face the outer surface 16 (upper surface) of the terminal accommodating portion 11 across a predetermined interval in the vertical direction (see FIG. 4).

As shown in FIG. 4, the female terminal fitting 27 includes a rectangular tube portion 28 in a front end part and a crimping portion 29 in the form of an open barrel in a rear end part. A resilient contact piece 30 is accommodated in the rectangular tube portion 28. A projection-like primary locking portion 31 is formed on the lower surface of the rectangular tube portion 28. A lower plate portion constituting the rectangular tube portion 28 is connected to a base plate portion of the crimping portion 29. The crimping portion 29 is conductively crimped to a front end part of a coated wire 32.

An upper plate portion 33 constituting the rectangular tube portion 28 is located higher than the crimping portion 29. Due to a height difference between the upper plate portion 33 and the crimping portion 29, a retaining portion 73 of the retainer 70 to be described later can be arranged above the crimping portion 29. In this way, the rear end of the upper plate portion 33 of the rectangular tube portion 28 can be locked to the tip of the retaining portion 73. In this way, the female terminal fitting 27 is held in a retained state.

The female terminal fitting 27 is inserted into the terminal accommodation chamber 12 from behind the first housing 10. The female terminal fitting 27 inserted to a proper position is held in the retained state by the primary locking portion 31 being locked by the locking lance 13. The coated wire 32 fixed to the female terminal fitting 27 is drawn out rearward from the first housing 10. The upper plate portion 33 is adjacent to and facing an upper wall portion of the terminal accommodation chamber 12.

As shown in FIGS. 1, 2 and 4, the retainer 70 is a single member including a rear wall portion 71, a pair of bilaterally symmetrical hooking portions 72, a plurality of the retaining portions 73, a holding portion 74 and a pair of bilaterally symmetrical movement restricting portions 75. The rear wall portion 71 is in the form of a flat plate having a plate thickness direction oriented in the front-rear direction. In a back view, the rear wall portion 71 is formed with a plurality of holes 76 penetrating in the front-rear direction (thickness direction of the rear wall portion 71). The rear wall portion 71 is formed with an escaping portion 77 by cutting a region corresponding to the terminal accommodation chambers 12 in the back view. The escaping portion 77 is open in the lower end edge of the rear wall portion 71 to avoid the interference of the coated wires 32 and the retainer 70.

The pair of hooking portions 72 are arranged on both left and right end parts of the front surface of the rear wall portion 71 (see FIG. 3). The hooking portion 72 is cantilevered forward from the front surface of the rear wall portion 71. A slit 72A is formed from a base end to a tip part in a vertically central part of each hooking portion 72. Each hooking portion 72 can be resiliently displaced in the lateral direction with the base end (part connected to the rear wall portion 71) thereof as a fulcrum.

As shown in FIG. 4, the plurality of retaining portions 73 are cantilevered forward from the front surface (surface facing the rear end of the first housing 10) of the rear wall portion 71. A projecting direction of the retaining portions 73 is parallel to an inserting direction of the female terminal fittings 27 into the first housing 10 and an assembling direction of the retainer 70 with the first housing 10. The respective retaining portions 73 are arranged closer to a lateral center than both left and right ends of the rear wall portion 71 in the lateral direction (not shown).

The retainer 70 is assembled with the rear end part of the terminal accommodating portion 11 from behind the first housing 10. In assembling the retainer 70, the pair of hooking portions 72 are slid in contact with and along the recesses 17 formed in the both left and right outer side surfaces of the terminal accommodating portion 11. In this way, the retainer 70 is positioned in the vertical direction with respect to the first housing 10 and guided with posture inclination in the vertical direction restricted.

The holding portion 74 is cantilevered forward from the front surface (surface facing the rear end of the first housing 10) of the rear wall portion 71. A projecting direction of the holding portion 74 is parallel to the inserting direction of the female terminal fittings 27 into the first housing 10 and the assembling direction of the retainer 70 with the first housing 10. The holding portion 74 is arranged in a laterally central part of the rear wall portion 71 in the lateral direction. An abutting surface 74A expanding perpendicular to the front-rear direction is formed on the tip of the holding portion 74.

As shown in FIG. 3, the pair of movement restricting portions 75 are arranged closer to the lateral center than the both left and right ends of the front surface of the rear wall portion 71. Each movement restricting portion 75 is cantilevered forward from the front surface of the rear wall portion 71. A tip part of the left movement restricting portion 75 is bent leftward. A tip part of the right movement restricting portion 75 is bent rightward. Each movement restricting portion 75 is resiliently displaceable in the lateral direction with the base end (part connected to the rear wall portion 71) thereof as a fulcrum.

In an assembling process of the retainer 70, the respective movement restricting portions 75 are resiliently deformed in directions toward the lateral center as the tip parts of the movement restricting portions 75 move forward on the inclined surfaces 14D of the rear protrusions 14B of the upper locked portions 14. Along with this, the respective hooking portions 72 are resiliently deformed laterally outward as the tip parts of the hooking portions 72 move forward on the inclined surfaces 18D of the rear locked portions 18B. Then, the tip parts of the respective movement restricting portions 75 resiliently return laterally outward after passing forward through the rear protrusions 14B of the upper locked portions 14, and face the rear protrusions 14B of the upper locked portions 14 from front to come into contact therewith (see FIG. 1). Then, the tip parts of the respective hooking portions 72 resiliently return toward the lateral center after passing forward through the rear locked portions 18B, the rear locked portions 18B enter the slits 72A, and the tip parts of the hooking portions 72 face the rear locked portion 18B from front to come into contact therewith (see FIG. 1). At this time, the tip of the holding portion 74 is located behind the arm body portion 23 (see FIG. 4). At this time, the retainer 70 is in a state arranged at an initial position before reaching a detection position to be described later. The retainer 70 arranged at the initial position in this way is restricted from being separated rearward from the first housing 10.

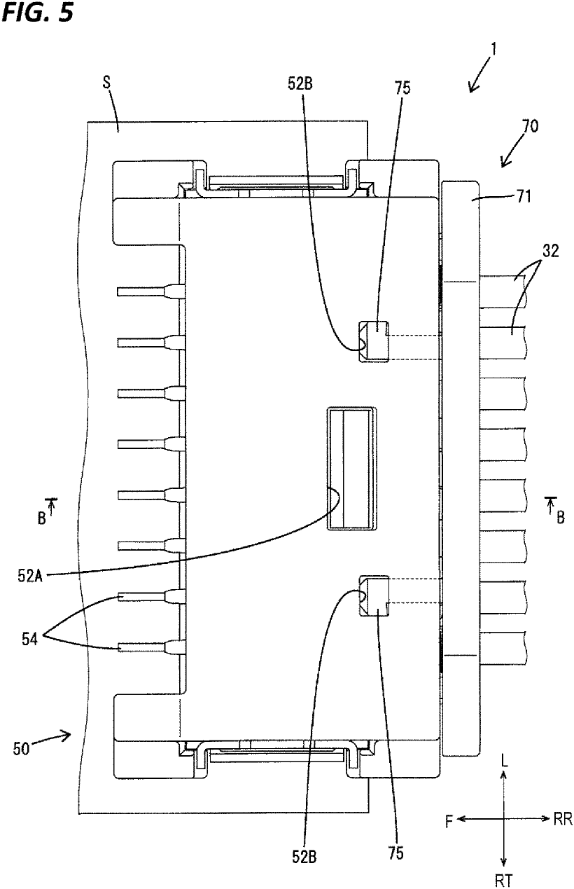

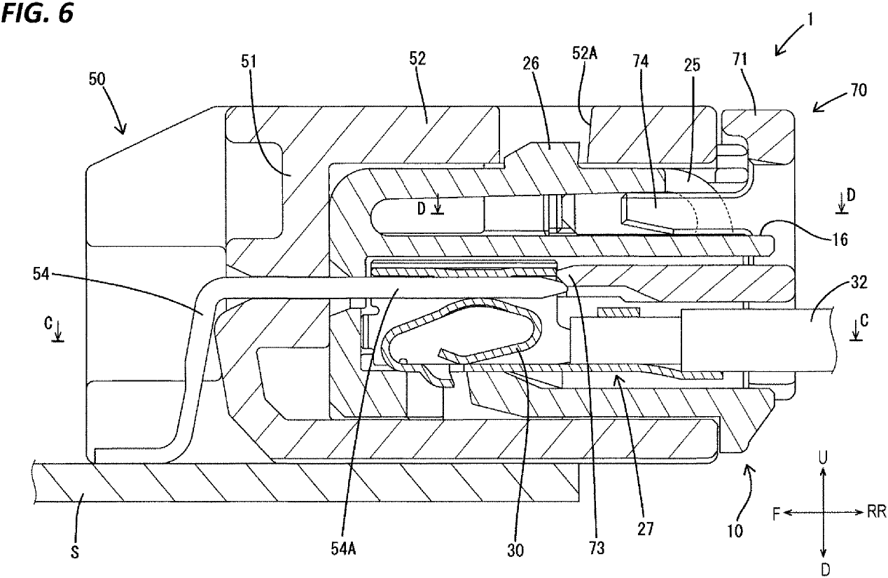

The first housing 10 having the retainer 70 arranged at the initial position can be connected to the second housing 50. As shown in FIGS. 5 and 6, the second housing 50 is mounted on a circuit board S. Male terminal fittings 54 are mounted in the second housing 50. The second housing 50 includes a wall-like terminal penetration portion 51 and a receptacle 52 in the form of a rectangular tube projecting rearward from the outer peripheral edge of the terminal penetration portion 51. The male terminal fitting 54 is passed through the terminal penetration portion 51. A tab 54A formed on the tip of the male terminal fitting 54 is accommodated in the receptacle 52. A base end part of the male terminal fitting 54 is fixed to the circuit board S by solder.

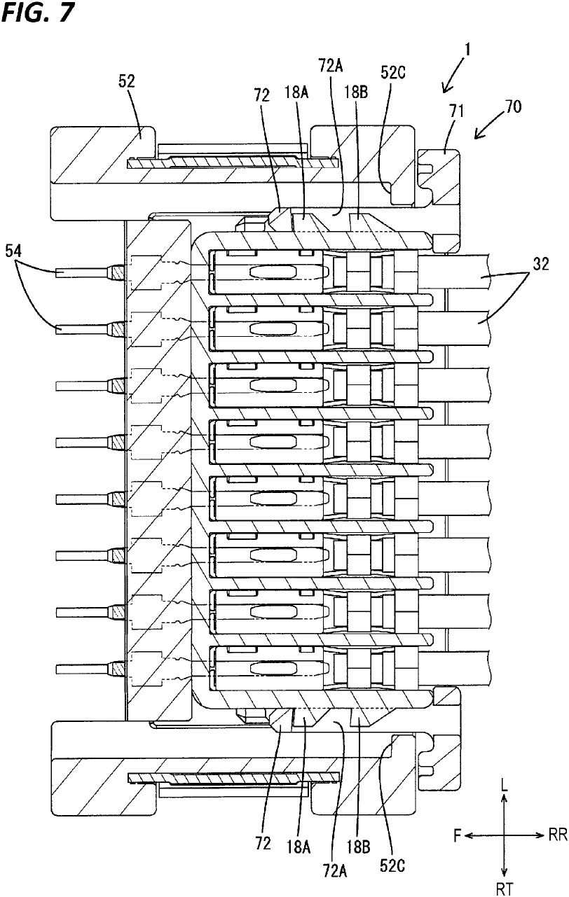

A lock hole 52A and a pair of openings 52B are formed in an upper surface part constituting the receptacle 52. The lock hole 52A is formed in a laterally central part of the upper surface part. The pair of openings 52B are formed to sandwich the lock hole 52A from left and right sides. As shown in FIG. 7, a pressing portion 52C is provided on each of left and right surface parts constituting the receptacle 52. The respective pressing portions 52C project toward a lateral center from rear end parts of the respective left and right surface parts of the receptacle 52.

When the connection of the first housing 10 having the retainer 70 arranged at the initial position and the second housing 50 is started, the protrusion 26 interferes with the upper surface part of the receptacle 52, whereby the lock arm 22 is deflected in a direction (downward direction) to approach the upper surface (outer surface 16) of the terminal accommodating portion 11 and displaced to an unlock position for releasing the locking.

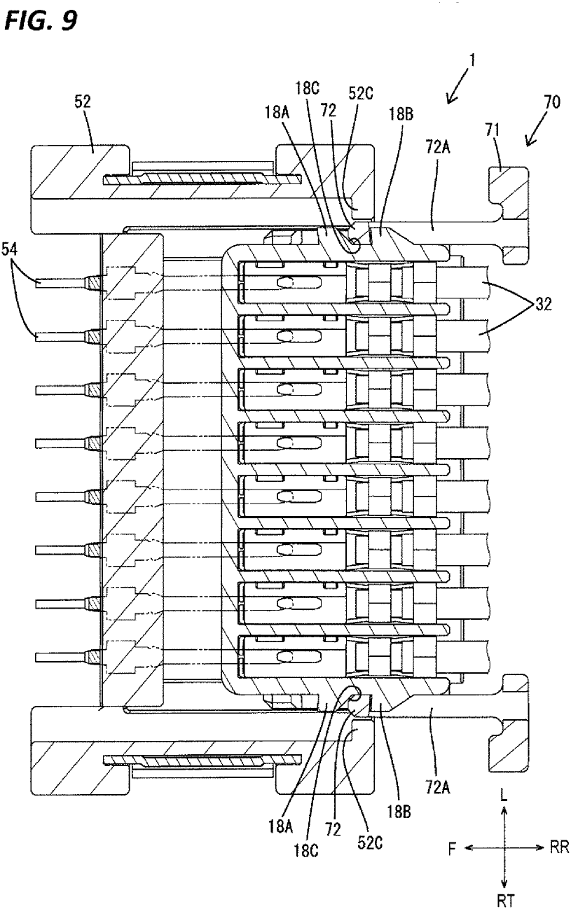

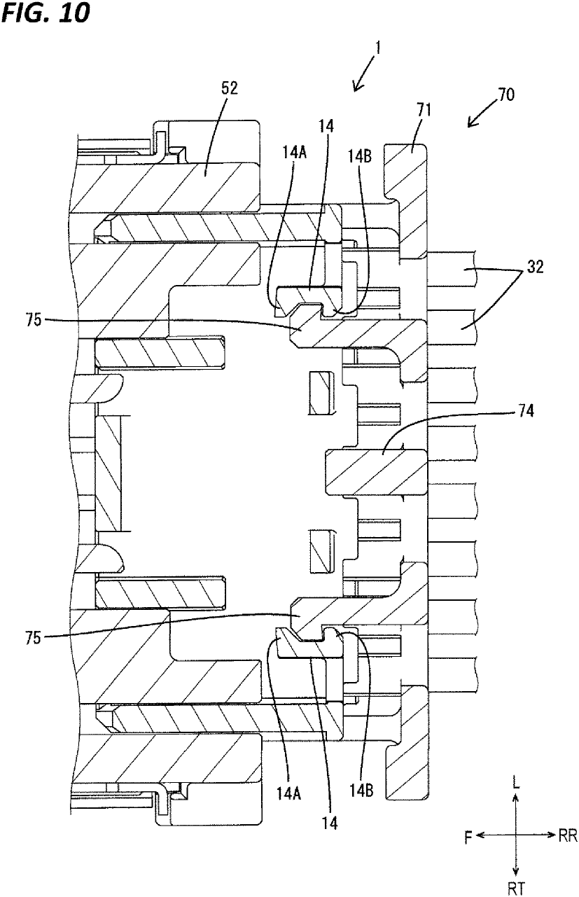

At this time, the tips of the pressing portions 52C of the receptacle 52 are adjacent to and facing the left and right outer surfaces of the tip parts of the pair of hooking portions 72 (see FIG. 9). In this way, the pair of hooking portions 72 are restricted from being resiliently deformed laterally outward by the pressing portions 52C of the receptacle 52. Thus, even if the pair of hooking portions 72 come into contact with the inclined surfaces 18C of the front locked portions 18A, the hooking portions 72 cannot be resiliently deformed laterally outward and cannot pass forward through the front locked portions 18A. That is, at this time, the hooking portions 72 are restricted from being locked to the front locked portions 18A by being held in a state butted against the inclined surfaces 18C of the front locked portions 18A by the pressing portions 52C. In this way, the retainer 70 at the initial position is restricted from being inserted into the first housing 10 and stopped in front. At this time, a part of the first housing 10 is seen when the openings 52B of the receptacle 52 are seen from above (not shown). At this time, the tip parts of the pair of movement restricting portions 75 are located between the rear protrusions 14B and the front protrusions 14A of the upper locked portions 14 (see FIG. 10).

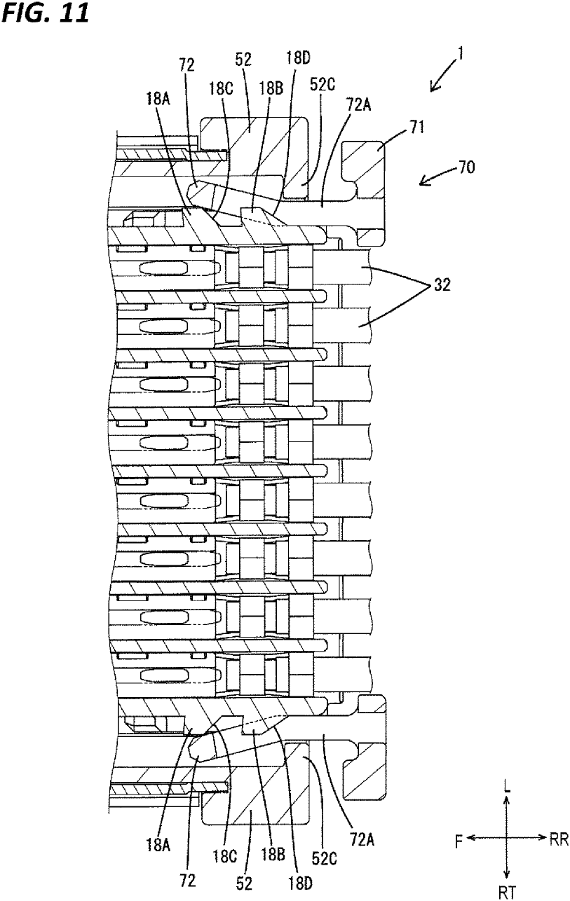

When the first and second housings 10, 50 reach a proper connection position, the lock arm 22 resiliently returns to the lock position from the unlock position, the protrusion 26 is locked into the lock hole 52A of the second housing 50 and the first and second housings 10, 50 are locked in a connected state. In this way, the connection of the first and second housings 10, 50 is completed. At this time, the tips of the pressing portions 52C of the receptacle 52 are adjacent to and facing the left and right outer surfaces of the base end parts of the pair of hooking portions 72 as shown in FIG. 11. In this way, the tip parts of the pair of hooking portions 72 are released from restriction by the pressing portions 52C. At this time, the pressing portions 52C allow the hooking portions 72 to be disengaged from the front locked portions 18A and allow the hooking portions 72 to be locked to the front locked portions 18A. In this way, the pressing portions 52C make the retainer 70 movable from the initial position to the detection position forward of the initial position. By a movement of the retainer 70 to the detection position, it can be detected that the first and second housings 10, 50 have reached the proper connection position.

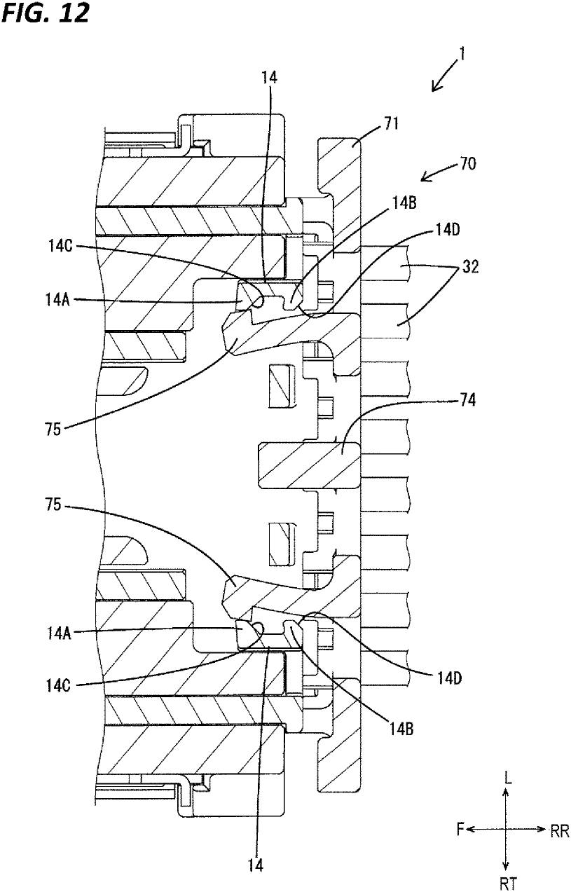

At this time, if the retainer 70 is moved forward and inserted into the first housing 10, the respective movement restricting portions 75 are resiliently deformed in the directions toward the lateral center as the tip parts of the movement restricting portions 75 move forward on the inclined surfaces 14C of the front protrusions 14A of the upper locked portions 14 (see FIG. 12). Along with this, the respective hooking portions 72 are resiliently deformed laterally outward as the tip parts of the hooking portions 72 move forward on the inclined surfaces 18C of the front locked portions 18 (see FIG. 11). Along with this, the holding portion 74 is inserted into between the arm body portion 23 and the outer surface 16 (upper surface) of the terminal accommodating portion 11 and between the pair of rear coupling portions 25.

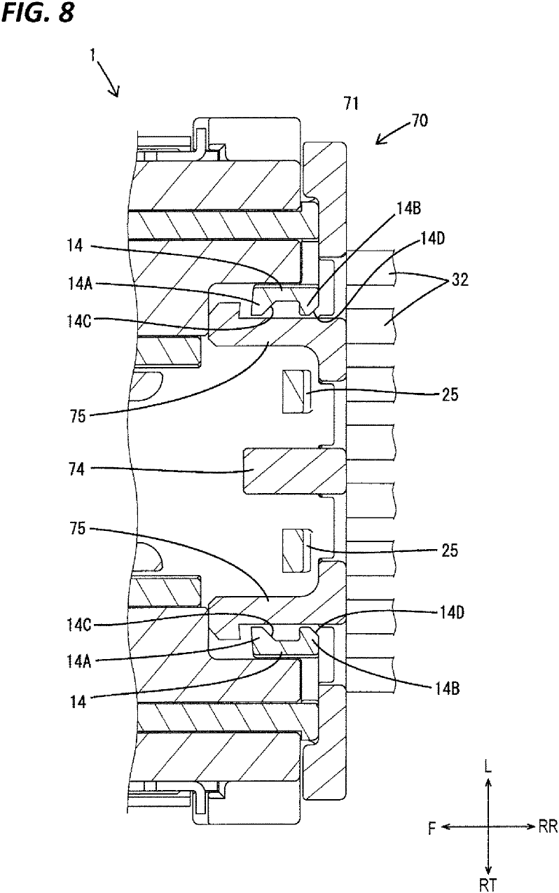

Then, the tip parts of the respective movement restricting portions 75 resiliently return laterally outward after passing forward through the front protrusions 14A of the upper locked portions 14, and face the front protrusions 14A of the upper locked portions 14 from front to come into contact therewith (see FIG. 8). At this time, the tip parts of the movement restricting portions 75 are seen when the openings 52B of the receptacle 52 are seen from above (see FIG. 5). That is, the retainer 70 is seen differently in the openings 52B in correspondence with the initial position and the detection position of the retainer 70.

Then, the tip parts of the hooking portions 72 resiliently return toward the lateral center after passing forward through the front locked portions 18A, the front locked portions 18A enter the slits 72A and the tip parts of the hooking portions 72 face the front locked portions 18A from front to come into contact therewith (see FIG. 7). That is, the hooking portions 72 are locked to the front locked portions 18A. Then, the rear wall portion 71 of the retainer 70 is located adjacent to the rear end of the terminal accommodating portion 11 (see FIG. 6). In this way, a movement of the retainer 70 from the initial position before reaching the detection position to the detection position where the retainer 70 is mounted on the first housing 10 is completed. That is, the retainer 70 cannot move from the initial position to the detection position until the first and second housings 10, 50 reach the connected state.

At this time, the holding portion 74 is arranged below the lock arm 22 (see FIG. 6). The tip of the holding portion 74 is located behind the protrusion 26 and in front of the pair of rear coupling portions 25 (see FIG. 6). The holding portion 74 suppresses the deflection and displacement of the lock arm 22 from the lock position to the unlock position with the first and second housings 10, 50 connected. Thus, a force for holding the connected state of the first and second housings 10, 50 is larger as compared to the case where the holding portion 74 is not provided.

If the retainer 70 is arranged at the detection position, the tip parts of the retaining portions 73 are adjacent to and facing the rear ends of the upper plate portions 33 of the rectangular tube portions 28 from behind. Accordingly, with the retainer 70 assembled with the first housing 10 and arranged at the detection position, even if the coated wire 32 is pulled rearward, the rear end of the upper plate portion 33 of the rectangular tube portion 28 comes into contact with the front end of the retaining portion 73. Thus, a rearward relative displacement of the female terminal fitting 27 can be restricted. The female terminal fitting 27 is reliably held in the retained state by the locking lance 13 of the first housing 10 and the retaining portion 73 of the retainer 70.

The first and second housings 10, 50 in the connected state can be separated by pressing the protrusion 26 locked in the lock hole 52A to set a state where the protrusion 26 is not locked in the lock hole 52A. Further, to move the retainer 70 from the detection position to the initial position, the pair of hooking portions 72 are resiliently deformed laterally outward to disengage the front locked portions 18A from the slits 72A. Along with this, the pair of movement restricting portions 75 are resiliently deformed toward the lateral center to displace the tip parts thereof closer to the lateral center than the front protrusions 14A. In this way, the retainer 70 can move from the detection position to the initial position. That is, the retainer 70 is mounted on the first housing 10 movably between the initial position and the detection position forward of the initial position.

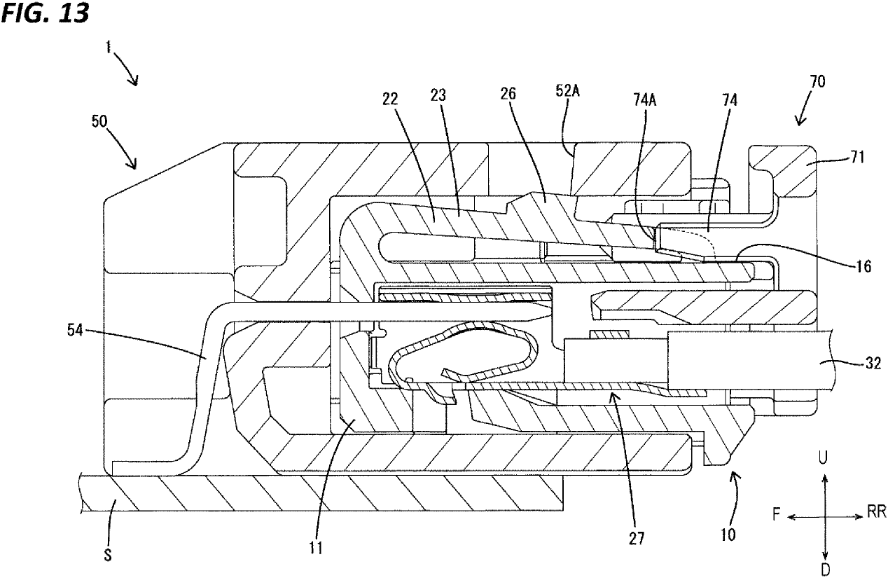

If the lock arm 22 does not resiliently return to the lock position from the unlock position and the protrusion 26 is not locked into the lock hole 52A as shown in FIG. 13 when the first and second housings 10, 50 reach the proper connection position, the lock arm 22 is displaced toward the unlock position rather than the lock position and close to the outer surface 16 (upper surface) of the terminal accommodating portion 11. If an attempt is made to displace the retainer 70 at the initial position to the detection position at this time, the abutting surface 74A formed on the tip of the holding portion 74 contacts the rear end of the arm body portion 23 from behind. Since a movement of the retainer 70 from the initial position to the detection position is restricted in this way, a displacement of the lock arm 22 toward the unlock position rather than the lock position can be easily detected.

Next, functions and effects of this embodiment are described.

The connector 1 of the present disclosure is provided with the first housing 10, the female terminal fittings 27 to be inserted into the first housing 10 from behind, the retainer 70 mounted on the first housing 10 movably between the initial position and the detection position forward of the initial position, the second housing 50 to be connected to the first housing 10, the front locked portions 18A provided on the first housing 10, the hooking portions 72 provided on the retainer 70 and to be locked to the front locked portions 18A, the pressing portions 52C provided in the second housing 50 and configured to hold the hooking portions 72 in a state butted against the front locked portions 18A and stop the retainer 70 at the initial position in front when the connection of the first and second housings 10, 50 is started and allow the hooking portions 72 to be disengaged from the front locked portions 18A and make the retainer 70 movable from the initial position to the detection position when the connection of the first and second housings 10, 50 is completed, the lock arm 22 provided on the first housing 10 and displaceable to the lock position for locking the first and second housings 10, 50 in the connected state by locking the second housing 50 and the unlock position for releasing the locking, and the holding portion 74 provided on the retainer 70 and configured to suppress a displacement of the lock arm 22 from the lock position to the unlock position in the connected state.

According to this configuration, since the pressing portions 52C allow the hooking portions 72 to be locked to the front locked portions 18A when the connection of the first and second housings 10, 50 is completed, the retainer 70 provided with the hooking portions 72 can be moved to the detection position. In this way, whether or not the connection of the housings has been completed can be easily grasped. Further, since a displacement of the lock arm 22 from the lock position to the unlock position is suppressed by the holding portion 74, a reduction in holding force for holding the connected state of the housings can be suppressed.

The abutting surface 74A for restricting a movement of the retainer 70 to the detection position by contacting the rear end of the lock arm 22 from behind if the lock arm 22 is displaced toward the unlock position rather than the lock position is formed on the tip of the holding portion 74 of the connector 1 of the present disclosure. According to this configuration, by the contact of the abutting surface 74A of the holding portion 74 with the rear end of the lock arm 22, it is possible to grasp a displacement of the lock arm 22 toward the unlock position rather than the lock position when the housings are connected. Thus, whether or not the housings are locked in the connected state can be detected.

The second housing 50 of the connector 1 of the present disclosure is formed with the openings 52B in which the retainer 70 is seen differently in correspondence with the initial position and the detection position of the retainer 70. According to this configuration, whether the retainer 70 is at the initial position or at the detection position can be discriminated based on how the retainer 70 is seen through the openings 52B. Thus, whether or not the retainer 70 is at the detection position can be confirmed, in addition to the connected state of the housings.

### <Other Embodiments>

The present disclosure is not limited to the above described and illustrated embodiment, but is represented by claims. The present disclosure is intended to include all changes in the scope of claims and in the meaning and scope of equivalents and also include the following embodiments.

The rear locked portions and the rear protrusions may not be provided.

The holding portion may be a single member. Specifically, the holding portion may be inserted into between the arm body portion and the outer surface of the terminal accommodating portion via an insertion hole formed in the retainer for the insertion of the holding portion after the first and second housings are connected.

List of Reference Numerals

| | |
|---|---|
| 1 | connector |
| 10 | first housing |
| 11 | terminal accommodating portion |
| 12 | terminal accommodation chamber |
| 13 | locking lance |
| 14 | upper locked portion |
| 14A | front protrusion |
| 14B | rear protrusion |
| 14C | inclined surface |
| 14D | inclined surface |
| 16 | outer surface |
| 17 | recess |
| 18A | front locked portion (locked portion) |
| 18B | rear locked portion |
| 18C | inclined surface |
| 18D | inclined surface |
| 22 | lock arm |
| 23 | arm body portion |
| 24 | front coupling portion |
| 25 | rear coupling portion |
| 26 | protrusion |
| 27 | female terminal fitting |
| 28 | rectangular tube portion |
| 29 | crimping portion |
| 30 | resilient contact piece |
| 31 | primary locking portion |
| 32 | coated wire |
| 33 | upper plate portion |
| 50 | second housing |
| 51 | terminal penetration portion |
| 52 | receptacle |
| 52A | lock hole |
| 52B | opening |
| 52C | pressing portion |
| 54 | male terminal fitting |
| 54A | tab |
| 70 | retainer (movable member) |
| 71 | rear wall portion |
| 72 | hooking portion |
| 72A | slit |
| 73 | retaining portion |
| 74 | holding portion |
| 74A | abutting surface |
| 75 | movement restricting portion |
| 76 | hole |
| 77 | escaping portion |
| S | circuit board |

1. A connector, comprising:
a first housing;
a terminal fitting to be inserted into the first housing from behind;
a movable member mounted on the first housing movably between an initial position and a detection position forward of the initial position;
a second housing to be connected to the first housing;
a locked portion provided on the first housing;
a hooking portion provided on the movable member, the hooking portion being locked to the locked portion;
a pressing portion provided in the second housing, the pressing portion holding the hooking portion in a state butted against the locked portion and stopping the movable member at the initial position in front when connection of the first and second housings is started and allowing the hooking portion to be disengaged from the locked portion and making the movable member movable from the initial position to the detection position when the connection of the first and second housings is completed;
a lock arm provided on the first housing, the lock arm being displaceable to a lock position for locking the first and second housings in a connected state by locking the second housing and an unlock position for releasing the locking; and
a holding portion provided on the movable member, the holding portion suppressing a displacement of the lock arm from the lock position to the unlock position in the connected state.

2. The connector of claim 1, wherein an abutting surface for restricting a movement of the movable member to the detection position by contacting a rear end of the lock arm from behind when the lock arm is displaced toward the unlock position rather than the lock position is formed on a tip of the holding portion.

3. The connector of claim 1, wherein the second housing is formed with an opening, the movable member being differently seen in the opening in correspondence with the initial position and the detection position of the movable member.
